(19) United States
(12) Patent Application Publication
(10) Pub. No.: US 2016/0132900 A1
(43) Pub. Date: May 12, 2016

(54) Informative Bounce Rate

(71) Applicant: Adobe Systems Incorporated, San Jose, CA (US)

(72) Inventors: Ashish Duggal, New Delhi (IN); Anmol Dhawan, Ghaziabad (IN); Walter Wei-Tuh Chang, San Jose, CA (US); Sachin Soni, New Delhi (IN)

(21) Appl. No.: 14/539,636

(22) Filed: Nov. 12, 2014

(51) Int. Cl. G06Q 30/02; G06F 17/30

(52) U.S. Cl. CPC G06Q 30/0201; G06F 17/3089

(57) ABSTRACT

In embodiments of informative bounce rate, keywords can be obtained from content of a Web page, and source content is extracted from a referring source that includes a selectable link to the Web page. The keywords that are obtained from content of the Web page are identified as also occurring in the source content of the referring source. A sentiment that is associated with each keyword can be determined, and a correspondence between the sentiment associated with a respective keyword and a bounce rate that is associated with the Web page is generated. The Web page can be identified as needing a redesign based on a high bounce rate and a corresponding overall positive source sentiment, which indicates visitors having a positive sentiment when visiting the Web page, yet a high number of the visitors bouncing from the Web page.

### BACKGROUND

Every day, millions of computer users visit Web pages as they surf the Internet, some by seeking a specific Web site, and others by simply clicking from one Web page to the next. Often, Web pages are designed to display advertisements that include selectable links, such as to a marketer's Web page or Web site. Many marketers, such as service providers and product manufacturers, seek to attract visitors to a Web page or Web site. Just as important, the marketers want to keep visitors engaged with the Web site, or pages of the Web site, once a visitor has navigated to visit a particular Web page.

Generally, most Web sites derive visitor traffic from referring sites or pages, from search engine referrals, and/or from social media referrals. The referring sites or pages include a link to a marketer's Web page. Similarly, the social media referrals, such as from Facebook™, Twitter™, and other social media sites, can include links to the marketer's Web page within the social discussions and comments. A search engine results page can display a link to the marketer's Web page, such as when a user initiates a keyword search in a browser application. Marketers also keep watch on the top referring keywords and phrases for a search engine, and generally buy them so that their Web page displays as a top result when a user searches for the particular keywords and/or phrases.

A marketer may see the benefit from a paid search as a high-volume of traffic to a particular Web page, yet experience visitors that leave (e.g., bounce) the Web page after only a short duration of time and/or without clicking through to other content associated with the Web page. This is reflected as a high bounce rate for the Web page, and typically indicates a design or function problem with getting visitors to stay and/or engage via the Web page. A bounce rate can be reflected as the percentage of users who navigate to a given Web page, but then leave without viewing another related page or associated content. Conventional analytics solutions only indicate the bounce rate for a particular Web page, and for a high bounce rate, indicate that the Web page is in need of a redesign in hopes of improving (e.g., reducing) the bounce rate for the Web page. As visitors to the Web page may click through from many different referring pages, advertisements, social sites, and the like, it can be difficult to discern how to improve or redesign the Web page in an effort to better engage and keep visitors interested in the marketing content on the Web page.

### SUMMARY

This Summary introduces features and concepts of informative bounce rate, which is further described below in the Detailed Description and/or shown in the Figures. This Summary should not be considered to describe essential features of the claimed subject matter, nor used to determine or limit the scope of the claimed subject matter.

Informative bounce rate is described. In one or more embodiments, keywords can be obtained from content of a Web page, and source content is extracted from a referring source that includes a selectable link to the Web page. The keywords that are obtained from content of the Web page are identified as also occurring in the source content of the referring source. A sentiment that is associated with each keyword can be determined, and a correspondence between the sentiment associated with a respective keyword and a bounce rate that is associated with the Web page is generated. The Web page can be identified as needing a redesign based on a high bounce rate and a corresponding overall positive source sentiment, which indicates visitors having a positive sentiment when selecting to visit the Web page, yet a high number of the visitors bouncing from the Web page after only a short duration of time and/or without clicking through to other content associated with the Web page.

In the described techniques, the keywords in the content of the Web page can be obtained utilizing natural language processing applied to the Web page, or may be obtained as provided by a marketer of the Web page. Further, as provided by the marketer, the keywords can be weighted according to an importance of the keywords, and the sentiment associated with a respective keyword determined based on the respective weighting of the keywords. A sentiment may also be associated with one or more keywords together in a phrase. An overall source sentiment of the source content from the referring source can be determined based on an average of the sentiments that are each associated with a respective keyword (or phrase of one or more keywords).

A referring source may be in the form of results that are generated by a search engine responsive to a keyword search, where one of the results links to a Web page. A referring source may also be an advertisement that includes a selectable link to the Web page, a social media page that includes the source content linking to the Web page, or any other different Web pages that include the selectable link to the Web page. The keywords that occur in the source content of the referring source can also be determined utilizing the natural language processing, and the keywords in the content of the Web page are compared to the keywords that occur in the source content to identify the similar keywords. The source content can be extracted from a page beginning of the referring source down to the selectable link to the Web page in the source content. Alternatively, the source content that is proximate the selectable link to the Web page in the source content can be extracted.

In different implementations of the techniques, marketer results can be generated that include the referring source, a number of Web page visits generated from the referring source, the bounce rate that is associated with the Web page for the number of Web page visits generated from the referring source, and an overall source sentiment of the referring source. Alternatively or in addition, the marketer results can be generated that include referring sources that each have a positive overall source sentiment, a number of Web page visits generated from the referring sources, the bounce rate that is associated with the Web page for the number of Web page visits generated from a respective referring source, and the positive overall source sentiment of the respective referring source. Alternatively or in addition, the marketer results can be generated that include a weighted, sentiment-based bounce rate that indicates Web pages having a high bounce rate and corresponding referring sources that have a positive overall source sentiment.

### BRIEF DESCRIPTION OF THE DRAWINGS

Embodiments of informative bounce rate are described with reference to the following Figures. The same numbers may be used throughout to reference like features and components that are shown in the Figures:

FIG. 1 illustrates an example system in which embodiments of informative bounce rate can be implemented.

FIG. 2 illustrates examples of marketer results in accordance with one or more embodiments of informative bounce rate.

FIG. 3 illustrates an example method of the embodiments of informative bounce rate.

FIG. 4 illustrates an example implementation of a natural language processing application in accordance with one or more embodiments.

FIG. 5 illustrates an example implementation of the natural language processing application and a sentiment analysis engine in accordance with one or more embodiments.

FIG. 6 illustrates an example implementation of the sentiment analysis engine in accordance with one or more embodiments.

FIG. 7 illustrates an example system with an example device that can implement one or more embodiments of informative bounce rate.

### DETAILED DESCRIPTION

Embodiments of informative bounce rate are described, and provide a marketer of a Web page feedback in the form of a correspondence determined between a bounce rate associated with a Web page and a sentiment associated with keywords that occur in content on the Web page and in source content from a referring source. The sentiment associated with a referring source about a marketer's product or service is an important factor to consider when evaluating the bounce rate that is associated with a Web page for the marketer's product or service. A bounce rate for a Web page can be reflected as the percentage of users who navigate to the Web page, but then leave without viewing another related page or associated content.

As noted above, most Web sites derive visitor traffic from referring sites or pages (referred to herein as “referring sources”) that include a link to a marketer's Web page; from search engine referrals and advertisements that include a link to the marketer's Web page; and from social media referrals that include links to the marketer's Web page within the social discussions and comments. The keywords can be identified in the Web page and in source content from the referring source utilizing natural language processing (e.g., a text analysis engine), and then compared to determine the similar keywords and/or phrases in the Web page and in the source content. As referred to herein, source content may include all or a portion of a referring source, such as all or a portion of a referring Web site or Web page that includes a selectable link to the marketer's Web page. Similarly, the source content may be all or part of an advertisement, one search engine referral or a list of search engine referrals, and/or all or a portion of a social media page or blog post.

A marketer may see a high-volume of traffic to a particular Web page, yet experience visitors that bounce after only a short duration of time and/or without clicking through to other content associated with the Web page. For example, a first Web page may have a 20% bounce rate and a second Web page may have a 30% bounce rate. Typically, a marketer would then focus on improving or redesigning the second Web page that has the higher bounce rate. The marketer may implement page design changes, such as any one or combination of changing the content, color schemes, an arrangement of the content, fonts, a context of the product or service that is being marketed, and/or make some content more prominent, as well as add links to videos, add additional images, and the like.

In this example, the marketer may focus on improving or redesigning the second Web page that has the higher bounce rate without taking into account the context of visitors' mind set when visiting the Web page, as can be derived from a determination of the sentiment of the source content. In embodiments, a sentiment of the source content can be determined utilizing natural language processing (e.g., a sentiment analysis engine), and the sentiment of the source content provides context or insight to a visitor's mind set when selecting a link to the marketer's Web page in a referring source. For example, the first Web page that has the 20% bounce rate may also have an overall positive sentiment associated with the source content of one or more referring sources, whereas the second Web page that has the higher 30% bounce rate may have an overall negative sentiment associated with the source content of the referring sources.

Given the positive sentiment associated with the source content that is associated with the first Web page, the marketer may determine to focus on the first Web page that has the lower bounce rate because, in context with the overall positive sentiment, the marketer would expect that visitors click through Web pages of the Web site (e.g., click to watch a video, click to select another associated Web page, etc.) and/or or stay longer to view and read about the product or service on the first Web page. The marketer may look to implement page design changes and improve the first Web page that has the lower bounce rate in an effort to keep more of the positive-minded visitors engaged with the Web page when visiting.

In embodiments, a Web page can be identified as needing a redesign based on a high bounce rate and a corresponding overall positive source sentiment, which indicates visitors having a positive sentiment when selecting to visit the Web page, yet a high number of the visitors bouncing from the Web page after only a short duration of time and/or without clicking through to other content associated with the Web page. For example, a social media site (e.g., a referring source) may include links to a Web page for a company's product, such as a new tablet device, and a post on the social media site states that “the new tablet device from Devices Company has a big screen, and the display quality is great.” The overall sentiment of this source content is positive, yet a high number of visitors may still bounce off the Web page when clicking through to visit the Web page. This is concerning to a marketer of the new tablet device.

Another post on the social media site may state that “the new tablet device from Devices Company is too big to fit in your pocket, and the battery drains quickly.” The overall sentiment of this source content is negative, and similarly, visitors may bounce off the Web page when clicking through to visit the Web page. However, without a determination as to the overall sentiment of the source content, both of these visitors bounces would appear the same to the marketer—i.e., visitors from a referring source clicked through to the Web page, and left shortly thereafter without being engaged. Given that the overall sentiment of source content can be determined in embodiments of informative bounce rate, a marketer can focus on improving the Web pages that may have a lower or higher bounce rate, yet attract visitors clicking through from referring sources having an overall positive sentiment.

While features and concepts of informative bounce rate can be implemented in any number of different devices, systems, networks, environments, and/or configurations, embodiments of informative bounce rate are described in the context of the following example devices, systems, and methods.

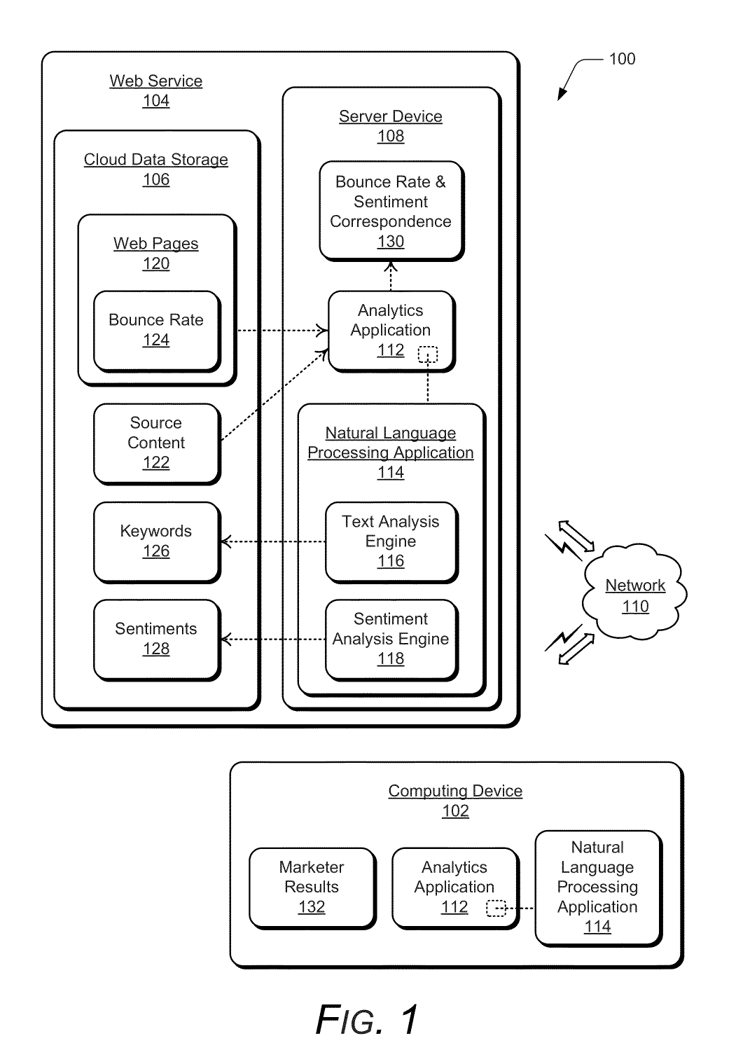

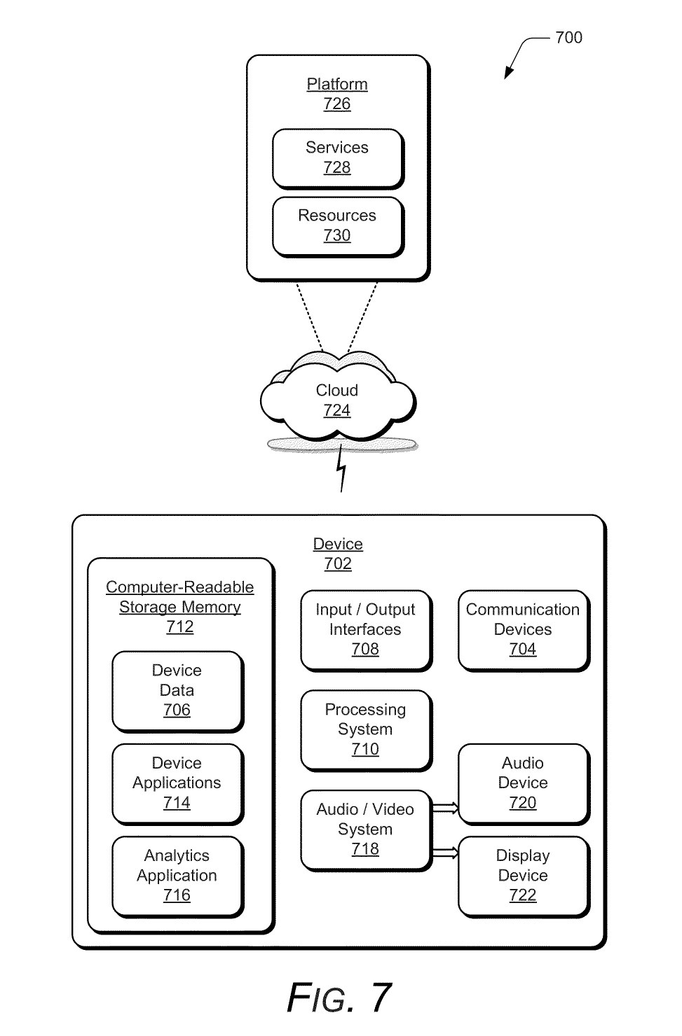

FIG. 1 illustrates an example system 100 in which techniques for informative bounce rate can be implemented. The example system 100 includes a computing device 102, such as any type of computer, mobile phone, tablet device, media playback device, and other computing, communication, gaming, entertainment, and/or electronic media devices. The computing device 102 can be implemented with various components, such as a processing system and memory, and with any number and combination of differing components as further described with reference to the example device shown in FIG. 7.

The example system 100 also includes a Web service 104 that users can access via the computing device 102. The Web service 104 is representative of any number of cloud-based access sites from which data and information is available, such as via the Internet, when posted to the Web, on an intranet site, on an external website, or any other similar location for on-line and/or network-based access. The Web service 104 includes cloud data storage 106 that may be implemented as any suitable memory, memory device, or electronic data storage for network-based data storage. The Web service 104 also includes a server device 108 that is representative of one or multiple hardware server devices of the Web service. The cloud data storage 106 and/or the server device 108 may include multiple server devices and applications, and can be implemented with various components, such as a processing system and memory, as well as with any number and combination of differing components as further described with reference to the example device shown in FIG. 7.

Any of the devices, servers, and/or services described herein can communicate via a network 110, such as for data communication between the computing device 102 and the Web service 104. The network can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The server device 108 implements an analytics application 112 that can be implemented as a software application or module, such as executable software instructions (e.g., computer-executable instructions) that are executable with a processing system of the server device to implement embodiments of informative bounce rate. The analytics application 112 can be stored on computer-readable storage media, such as any suitable memory device (e.g., the cloud data storage 106) or electronic data storage implemented by the server device 108 and/or by the Web service 104. In this example, the analytics application 112 can include a natural language processing application 114 that implements a text analysis engine 116 and a sentiment analysis engine 118 as software modules or components of the natural language processing application 114.

Although shown and described as integrated applications, the analytics application 112 and the natural language processing application 114 may be implemented as separate applications that are executed independently on the server device 108. Additionally, the computing device 102 can implement a version of the analytics application 112 and the natural language processing application 114, such as software applications that are executable with a processing system of the computing device 102 to implement embodiments of informative bounce rate. For example, a user of the client device 102 may request content of Web pages 120 and source content 122 of referring sources from the Web service 104 via the network 110 for informative bounce rate analysis at the computing device 102.

In this example, the Web service 104 can obtain content of Web pages 120 and source content 122 of referring sources, which is maintained by the cloud data storage 106. Each of the Web pages 120 also has an associated bounce rate 124, which can be stated as the percentage of users who navigate to a Web page, but then leave without viewing another related page or associated content. As noted above, most Web sites derive visitor traffic from referring sites or pages (referred to herein as “referring sources”) that include a link to a marketer's Web page; from search engine referrals and advertisements that include a link to the marketer's Web page; and from social media referrals that include links to the marketer's Web page within the social discussions and comments.

In implementations, the analytics application 112 can extract the source content 122 from a referring source. For example, the source content may be extracted from a page beginning of a referring source down to the selectable link to the Web page in the source content. This represents a user reading the content on a referring Web page, blog post, or social media site down to where the selectable link to the Web page is encountered, and the user then selecting the link to visit the Web page. Alternatively, the analytics application 112 can extract the source content 122 that is proximate the selectable link to the Web page in the source content, such as the source content that is above, below, and around the selectable link to the Web page. Determinations of the source content from one or more referring sources by the analytics application 112 is further described below. The analytics application 112 can be implemented to determine referring sources URLs, such as in Adobe Analytics that supports generating a referring domains report to identify how many referrers are coming from each of different Web sites, and provides information about the unique referring URLs for each of the Web sites. It may be noted that a referring source could change over time, such as when the referral source is cached and then changed before being evaluated. In implementations, the sentiment analysis that corresponds to a referring source can also be cached so that it corresponds to the cached referring source.

In embodiments, a Web page 120 and/or the source content 122 of a referring source can be input to the analytics application 112, which includes the natural language processing application 114. The text analysis engine 116 of the natural language processing application 114 can determine the keywords 126 (e.g., important keywords) from content of the Web page 120, as well as determine keywords 126 in the source content 122 from one or more referring sources. Alternatively, the keywords 126 may be obtained as provided by a marketer of the Web page. Further, as provided by the marketer, the keywords can be weighted according to an importance of the keywords. The analytics application 112 can then compare the keywords 126 in the content of the Web page 120 to the keywords 120 that occur in the source content 122 to identify the similar keywords.

The text analysis engine 116 of the natural language processing application 114 may be implemented with Adobe Sedona or as any other natural language processing engine. Part of speech (POS) tagging can be performed by the text analysis engine 116 to generate the keywords 126 that represent the Web page 120 (also referred to as the target site or target page—e.g., the target page of the selectable link that is included in the source content of the referring source). An example implementation of a natural language processing engine that performs POS tagging is described below. In the example described above, the Devices Company may have a Web page to promote their new tablet device, and the text analysis engine 116 can determine the keywords “Devices Company”, “tablet device”, “display”, etc. of the target page. The important keywords are identified as Imp_Key(i) for a marketer's Web page or site.

The text analysis engine 116 also determines the keywords of the source content 122 from the referring source, such as the social media site in the example, with the source content that states “the new tablet device from Devices Company has a big screen, and the display quality is great” with an overall positive source sentiment, and “the new tablet device from Devices Company is too big to fit in your pocket, and the battery drains quickly” with an overall negative source sentiment. The text analysis engine 116 can determine the keywords “Devices Company”, “new tablet device”, “display quality”, “battery”, etc. of the source content.

The sentiment analysis engine 118 of the natural language processing application 114 is implemented to determine the sentiments 128 that are each associated with the keywords and/or phrases, and the analytics application 112 generates a correspondence 130 between the sentiment 128 that is associated with a respective keyword 126 and a bounce rate 124 that is associated with a Web page 120. For the keywords 126 that are provided by a marketer of the Web page 120, where the keywords can be weighted according to an importance of the keywords, the analytics application 112 can generate the sentiment 128 associated with a respective keyword based on the respective weighting of the keyword.

For the source referring pages and/or search engine referrals that include a selectable link to the Web page, and from where a visitor navigates to the Web page, the sentiment analysis engine 118 determines the source sentiment corresponding to each of the keywords generated by the text analysis engine 116. The source content 122 of a referring source can be extracted with a natural language processing engine, and the term frequency for each keyword in Imp_Key(i) is determined in the source content. For search engine referrals, the source content can be extracted as the displayed content of all the search results near an advertisement or selectable link to the marketer's Web site or Web page. The term frequency for i^{th} keyword in Imp_Key(i) in the source content from a referring source can either be zero or greater than zero, and any keywords having a term frequency in a source is zero will be either ignored or their sentiment can be marked neutral.

The sentiment analysis engine 118 of the natural language processing application 114 can be implemented as a keyword-level sentiment engine that determines the sentiment 128 associated with a particular keyword in given content, and determines the sentiment of every keyword having a term frequency that is greater than zero in the source content 122 from a referring page. For example, the sentiment analysis engine 118 determines the sentiment of each of the keywords “Devices Company”, “new tablet device”, “display quality”, “battery”, etc. of the source content.

The analytics application 112 is also implemented to take an average of sentiment of all the keywords and determine an overall source sentiment of the source content 122 from a referring source based on an average of the sentiments 128 that are each associated with a respective keyword 126 (or phrase of one or more keywords). Further, the analytics application 112 can take a weighted average of the sentiments 128 of all the keywords 126, where the weight of a keyword depends on the relative importance of the keyword. For example, both “new tablet device” and “display quality” are important phrases of the keywords, yet a marketer can chose to give more weight to the phrase “display quality” as compared to the phrase of keywords “new tablet device.” The analytics application 112 can generate marketer results 132 as enhanced analytics metrics detailing the overall sentiment of source content from a referring source, along with the bounce rate of the target page for the marketer. A Web page 120 can then be identified as needing a redesign or improvement based on a high bounce rate 124 and a corresponding overall positive source sentiment 128, which indicates that visitors have a positive sentiment when selecting to visit the Web page, yet a high number of the visitors bounce from the Web page after only a short duration of time and/or without clicking through to other content associated with the Web page.

As noted above, the sentiment analysis engine 118 of the natural language processing application 114 provides the ability to extract keyword-level sentiment, and the sentiment analysis engine 118 can be implemented with a sentiment engine such as AlchemyAPI. As described further below, the sentiment analysis engine 118 can detect, extract, and weight sentence affect and sentiment using a general purpose sentiment vocabulary combined with a NLP engine. The sentiment analysis engine uses as input POS and tagged sentences, and then determines and scores the positive, negative, and neutral sentiment.

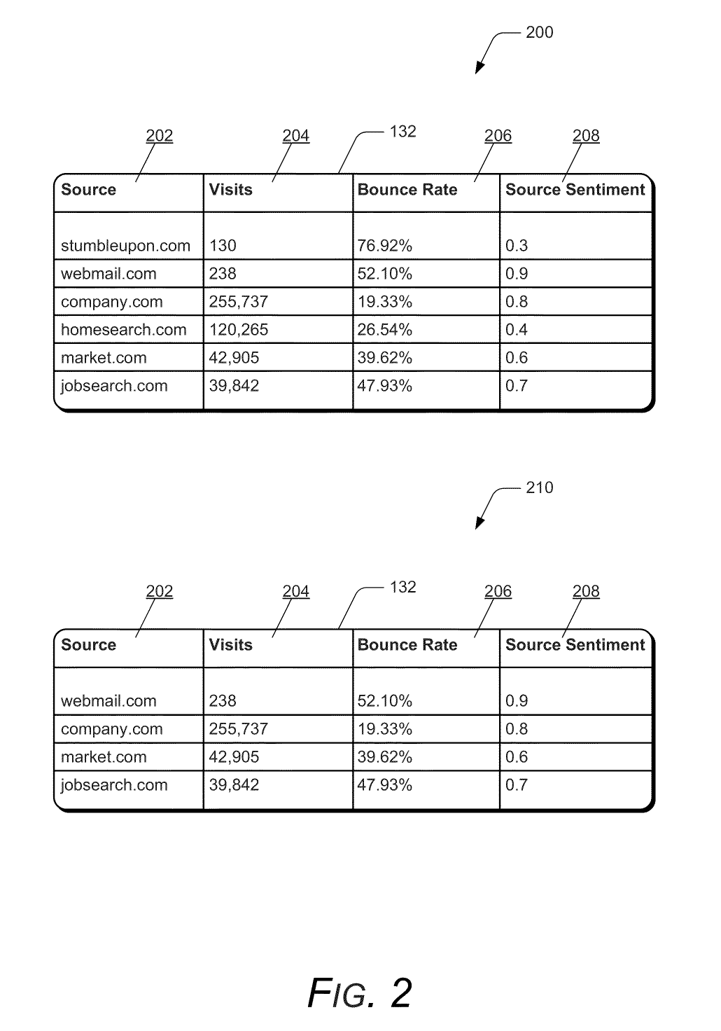

In different implementations of the techniques, the analytics application 112 is implemented to generate marketer results 132, such as for display to a user of the computing device 102. A marketer can receive a break-down of the bounce rate corresponding to the referral source site sentiment from where a user clicks through to visit a Web page, and from the marketer results 132, the marketer can decide where to apply efforts to emphasize and/or improve content of a Web page for an improved bounce rate. For example, FIG. 2 illustrates an example 200 of the marketer results 132 that is generated to include a list of the referring sources 202, a number of Web page visits 204 generated from each of the referring sources, the bounce rate 206 that is associated with a Web page for the number of Web page visits generated from the respective referring sources, and an overall source sentiment 208 of the referring sources. Note that a source sentiment can vary from zero to one (0 to 1), where zero (0) is the most negative indication of sentiment, and one (1) is the most positive indication of sentiment. For example, the most negative source sentiment is 0.3 associated with the source content from the referring source “stumbleupon” in the marketer results 132, and the most positive source sentiment is 0.9 associated with the source content from the referring source “webmail”.

Based on the example marketer results 132 shown in FIG. 2, a marketer can see that for the 130 visitors corresponding to the first row and the high 76.92% bounce rate 206, the source sentiment 208 is overall negative and therefore, this bounce rate should not be the focus of content improvement. Alternatively, for the 238 visitors corresponding to the second row and the 52.10% bounce rate, the source sentiment 208 is overall very positive, and therefore, the marketer can focus on redesigning and content improvement for the associated Web page.

Alternatively, a marketer may have a preference to see the bounce rate only for referring sources having an overall positive sentiment value (e.g., 0.5 and above), such as shown in the example 210 in FIG. 2. The marketer results 132 can be generated that include referring sources 202 each having a positive overall source sentiment 208, the number of Web page visits 204 generated from the referring sources, and the bounce rate 206 that is associated with the Web page for the number of Web page visits generated from a respective referring source. As an option, a slider or other selectable user interface control corresponding to source sentiment value) can be displayed to adjust the source sentiment value, and only the marketer results that correspond to the selected source sentiment values higher than specified by the marketer are displayed.

Alternatively or in addition, the marketer results 132 can be generated that include a weighted sentiment-based bounce rate that indicates Web pages having a high bounce rate 206 and corresponding referring sources 202 that have a positive overall source sentiment 208. A concept of weighted sentiment-based bounce rate can help a marketer select the Web pages to be redesigned and improved in the most optimized manner. The marketer will see the weighted sentiment based bounce rate information displayed and can choose to first redesign the Web pages having a high positive sentiment based bounce rate.

As noted above, the text analysis engine 116 of the natural language processing application 114 may be implemented with Adobe Sedona or as any other natural language processing engine. For example, an n-gram POS (part of speech) tagger can be applied to the target page content, or by using natural language toolkit (NLTK) POS tagging. In an implementation, the important keywords ‘K_T’ (e.g., the keywords 126) can be identified in a Web page by a first step to tokenize the raw text of the target page or site, where the “tokens=nltk.word_tokenize(raw)” and then converting the tokenized text to lower case using “words=[w.lower( ) for w in tokens].” A process of stemming then finds the stems of the words, in which NLTK implements two stemmers, Porter and Lancaster, both of which may be utilized for “porter=nltk.PorterStemmer( )”, “lancaster=nltk.LancasterStemmer( )”, “stemedwords_first_pass=[porter.stem(t) for t in words]”, and “stemedwords_final_pass=[lancaster.stem(t) for t in stemedwords_first_pass].” A lemmatization can be applied to generally group together different inflected forms of a keyword that are then considered as a single item or term, where “wnl=nltk.WordNetLemmatizer( )” and completely_normalized_words=[wnl.lemmatize(t) for t in stemedwords_final_pass].”

Then the text analysis engine 116 performs POS tagging as the process of classifying words into their parts of speech and labeling them accordingly (e.g., referred to as part-of-speech tagging, POS-tagging, or simply tagging). The POS tagging identifies the keywords as a noun, proper noun, verb, adjective, pronoun, article, etc., and the “pos_tagged_words=nltk.pos_tag (completely_normalized_words).” In this example, a marketer is interested in the nouns and proper nouns in the source content (e.g., “Devices Company”, “tablet”, “display”, “battery”, etc.).

In implementations of informative bounce rate, selectable features can be provided to a marketer, such as a preference to see the bounce rate analytics metrics for a Web page on the basis of the sentiment of the source content from the referring page, search results, or social conversation. Alternatively, the marketer may prefer to include only the bounce rate analytics metrics where the source sentiment at the referring page, search results, or social conversation is above a threshold T, as specified by the marketer. Alternatively, the marketer may prefer to see the weighted bounce rate, which also includes the sentiment of the source content from the referring page, search results, or social conversation.

The Web page content C_T of the target site or Web page can be applied to the text analysis engine 116, such as Adobe Sedona or any other natural language processing (NLP) engine. The analytics application 112 can then perform POS tagging on the content C_T to generate a keywords vector K_T, which represents the gist of the target site or Web page by identifying the important keywords, such as the nouns, proper nouns, etc., and by removing any pronouns, articles etc. For example, the keywords vector K_T will include the keywords and phrases “Devices Company”, “tablet”, “device”, “display”, “battery”, etc. from the blog source content, as in the ongoing example. In an alternate implementation, the marketer can provide a list of the important keywords for a target Web page, as well as a weight corresponding to each of the keywords, where the keyword weight specifies how important the keyword is for the target site or Web page.

For every Web page where a user enters on the target Web site, the analytics application 112 can identify the source S from where the visitor clicked through to the Web page, and the referring source will be a referring site or page S_RP, a search engine referral S_SE, or a social channel referral S_SC. The analytics application 112 can then determine the source content C_S as follows: for the referring source as S_RP, it is the content corresponding to the source page from where the visitor came before bouncing off; for the referring source as S_SC, it is the content corresponding to the source page from where the visitor came before bouncing off; for the referring source as S_SE, it is the content corresponding to the search results description in the vicinity of the advertisement.

The analytics application 112 is implemented to initialize the following variables: Source_Sentiment=0; Total_Sentiment=0; and Keywords_Present=0. For every keyword K_T_i in K_T, the analytics application determines whether K_T_i is present in C_S. If it is, then the next step is to implement the sentiment analysis engine 118 (such as AlchemyAPI) to determine the sentiment score K_T_S_i, and the Total_Sentiment=Total_Sentiment+K_T_S_i. Further, if the marketer has provided the list of keywords along with the associated weights, then the Total_Sentiment=Total_Sentiment+K_T_S_i*K_T_W_i, where K_T_W_i is the weight of the i^{th} keyword. The Keywords_Present=Keywords_Present+1. Further, if the marketer has provided the list of keywords along with the associated weights, then the Keywords_Present=Keywords_Present+K_T_i and the Source_Sentiment=Total_Sentiment/Keywords_Present. As an advanced option, marketer can also specify to include the term frequency of the keywords in the source content while calculating the source sentiment, in which case the Total_Sentiment would be updated as: Total_Sentiment=Total_Sentiment+K_T_S_i*K_T_F_i, where K_T_F_i is the term frequency of i^{th} keyword, and Keywords_Present would be updated as Keywords_Present=Keywords_Present+K_T_F_i.

If the marketer selects the preference to see the bounce rate analytics metrics for a Web page on the basis of the sentiment of the source content from the referring page, search results, or social conversation (as specified above), the marketer results 132 include enhanced analytics metrics detailing the source or referral site sentiment along with the bounce rate information. If the marketer selects the preference to include only the bounce rate analytics metrics where the source sentiment at the referring page, search results, or social conversation is above a threshold T as specified by the marketer, then only those bounces having a Relevant_Source_Sentiment above the threshold T specified by the marketer will be included in the analytics metrics to be presented to the marketer. If the marketer selects the preference to see the weighted bounce rate, which also includes the sentiment of the source content from the referring page, search results, or social conversation, then instead of the default value of one (1) for the bounce rate, a value of Relevant_Source_Sentiment (on a scale of 0 to 1) can be used in determining the weighted bounce rate.

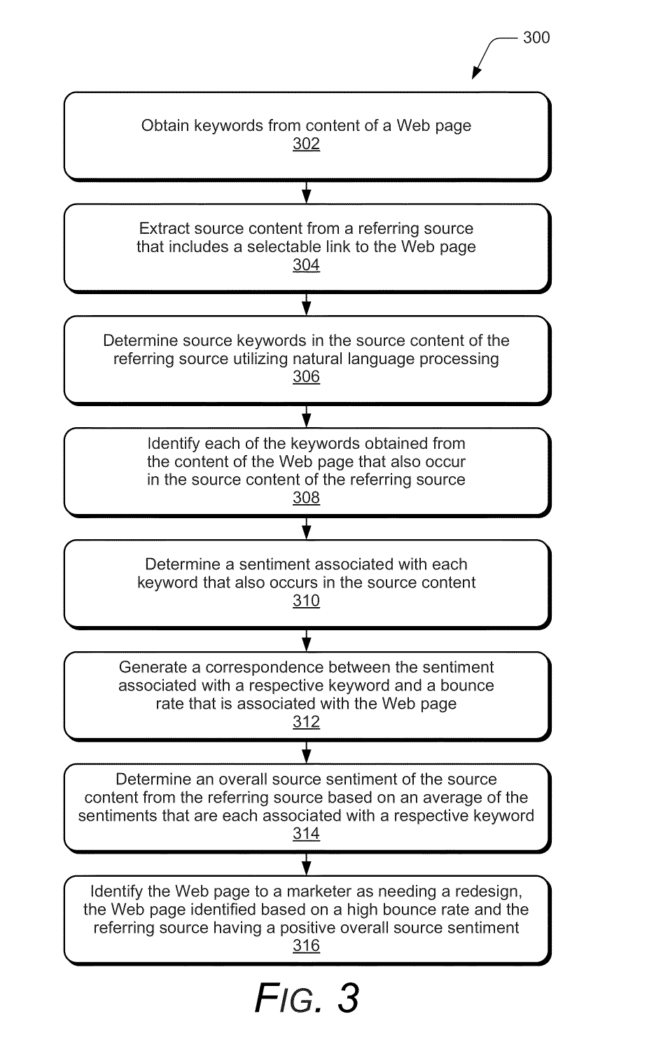

Example method 300 is described with reference to FIG. 3 in accordance with one or more embodiments of informative bounce rate. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of informative bounce rate, and is generally described with reference to the example system shown in FIG. 1. The order in which the method is described is not intended to be construed as a limitation, and any number or combination of the method operations can be combined in any order to implement a method, or an alternate method.

At 302, keywords are obtained from content of a Web page. For example, the text analysis engine 116 of the analytics application 112 obtains the keywords 126 from the content of a Web page 120 utilizing natural language processing applied to the Web page. Alternatively, the keywords 126 may be obtained as provided by a marketer of the Web page. Further, as provided by the marketer, the keywords 126 can be weighted according to an importance of the keywords, and the sentiment associated with a respective keyword determined based on the respective weighting of the keyword.

At 304, source content is extracted from a referring source that includes a selectable link to the Web page. For example, the analytics application 112 extracts the source content 122 from a referring source that includes a selectable link to the Web page 120. The source content 122 can be extracted from a page beginning of the referring source down to the selectable link to the Web page in the source content. Alternatively, the source content that is proximate the selectable link to the Web page in the source content can be extracted. A referring source may be in the form of results that are generated by a search engine responsive to a keyword search, where one of the results links to a Web page. A referring source may also be an advertisement that includes a selectable link to the Web page, a social media page that includes the source content linking to the Web page, or any other different Web pages that include the selectable link to the Web page.

At 306, source keywords are determined in the source content of the referring source utilizing natural language processing. For example, the text analysis engine 116 of the analytics application 112 determines the source keywords 126 in the source content 122 of the referring source utilizing natural language processing (e.g., the natural language processing application 114) applied to the source content.

At 308, each of the keywords obtained from the content of the Web page that also occur in the source content of the referring source are identified. For example, the analytics application 112 identifies each of the keywords 126 that also occur in the source content 122 by comparing the keywords from the content of the Web page 120 to the source keywords determined from the source content 122.

At 310, a sentiment associated with each keyword that also occurs in the source content is determined. For example, the sentiment analysis engine 118 of the analytics application 112 determines a sentiment 128 associated with each keyword 126 (or phrase of keywords) that also occurs in the source content 122.

At 312, a correspondence between the sentiment associated with a respective keyword and a bounce rate that is associated with the Web page is generated. For example, the analytics application 112 generates a correspondence 130 between the sentiment 128 that is associated with a respective keyword 126 and a bounce rate 124 that is associated with a Web page 120.

At 314, an overall source sentiment of the source content from the referring source is determined based on an average of the sentiments that are each associated with a respective keyword. For example, the analytics application 112 determines an overall source sentiment of the source content 122 from a referring source based on an average of the sentiments 128 that are each associated with a respective keyword 126 (or phrase of one or more keywords).

At 316, the Web page is identified to a marketer as needing a redesign, where the Web page is identified based on a high bounce rate and the referring source having a positive overall source sentiment. For example, the analytics application 112 generates marketer results 132, such as for display to a user of the computing device 102. The marketer results 132 can be generated to include the referring source, a number of Web page visits generated from the referring source, the bounce rate that is associated with the Web page for the number of Web page visits generated from the referring source, and an overall source sentiment of the referring source. Alternatively or in addition, the marketer results 132 can be generated that include referring sources that each have a positive overall source sentiment, a number of Web page visits generated from the referring sources, the bounce rate that is associated with the Web page for the number of Web page visits generated from a respective referring source, and the positive overall source sentiment of the respective referring source. Alternatively or in addition, the marketer results 132 can be generated that include a weighted sentiment-based bounce rate that indicates Web pages having a high bounce rate and corresponding referring sources that have a positive overall source sentiment.

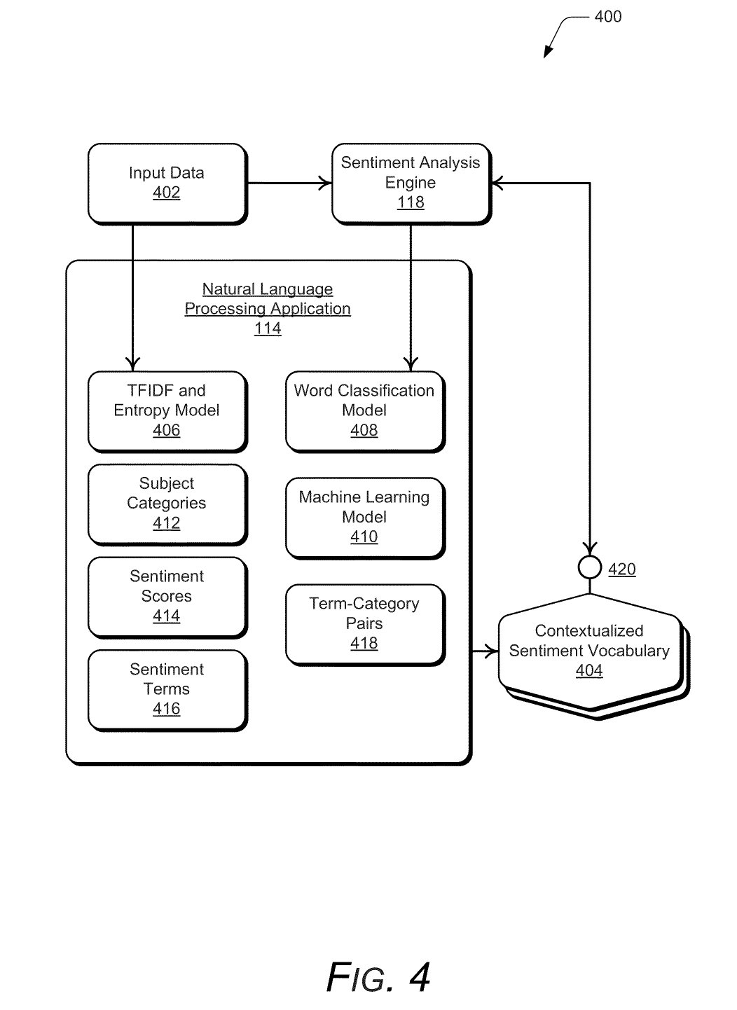

FIG. 4 illustrates an example implementation 400 of the natural language processing application 114 in embodiments of informative bounce rate. The natural language processing application 114 can receive input data 402, such as the target Web page 120 and the source content 122 as described with reference to FIG. 1. The natural language processing application 114 implements one or more models to generate contextualized sentiment vocabularies 404, such as a term frequency inverse document frequency (TFIDF) and entropy model 406, a word classification model 408, and/or a machine learning model 410. In the TFIDF and entropy model 406, the TFIDF reflects the importance of a word (also referred to as a term) in the source content of a referring source. The TFIDF value increases proportionally to the number of times that a term appears in the source content, and can be offset by the frequency that the term appears in the source content. In this example 400, the sentiment analysis engine 118 also receives the input data 402 and implements techniques for contextual sentiment text analysis of the source content.

The natural language processing application 114 is implemented to identify and rank all sentiment keywords by variance in polarity in the source content 402 by computing a specialized weighted entropy score for each term. In implementations, the natural language processing application 114 can determine subject categories 412 of the source content, and generate sentiment scores 414 for the sentiment terms 416 that are expressed as sentiments in the source content of referring sources. A sentiment score 414 can be generated based on a context of the term 416 as it pertains to a category 412 and the rating of the source content. The natural language processing application also generates sentiment scores for a term across multiple categories that are determined from the rated reviews, where the sentiment scores each indicate a degree to which the term is positive or negative for an associated category. The natural language processing application is implemented to then determine a polarity of the term-category pairs 418 based on the corresponding sentiment scores.

The natural language processing application 114 is implemented to generate one or more affect and sentiment vocabularies 404 in a semi-supervised or automatic mode in which sentiment polarity scores are assigned to each sentiment term in a vocabulary list depending on a specific context or domain of usage for the sentiment term. In implementations, the contextual analysis application can implement a machine learning workflow to generate the theoretic TFIDF word database. The contextual analysis application then utilizes the TFIDF database to compute a weighted entropy score for each sentiment term for each specific domain or context. The results can be persisted into a fast machine readable and run-time (i.e., analysis time) loadable data structure that represents the contextualized sentiment term vocabulary for use by the sentiment analysis engine 118, which can increase the accuracy and coverage of the emotion and sentiment analysis.

The natural language processing application 114 can also implement an interface by which the sentiment analysis engine 118 can access the contextualized sentiment vocabulary 404 through a module API 420 (application program interface). The API 420 can be implemented as a representational state transfer (RESTful) interface, or as a direct set of method calls using a remote procedure call (RPC) interface. The sentiment analysis engine 118 can provide, via the API, one or more keywords to be analyzed, where the input data 402 keywords can be preprocessed through a natural language segmenter, tokenizer, part-of-speech, and phrase expression tagger to properly validate the input terms for contextualized sentiment scoring. The sentiment analysis engine can efficiently retrieve sentiment polarity and intensity information from the run-time contextualized sentiment vocabulary 404 to generate the sentiment associated with a keyword of the source content from a referring source.

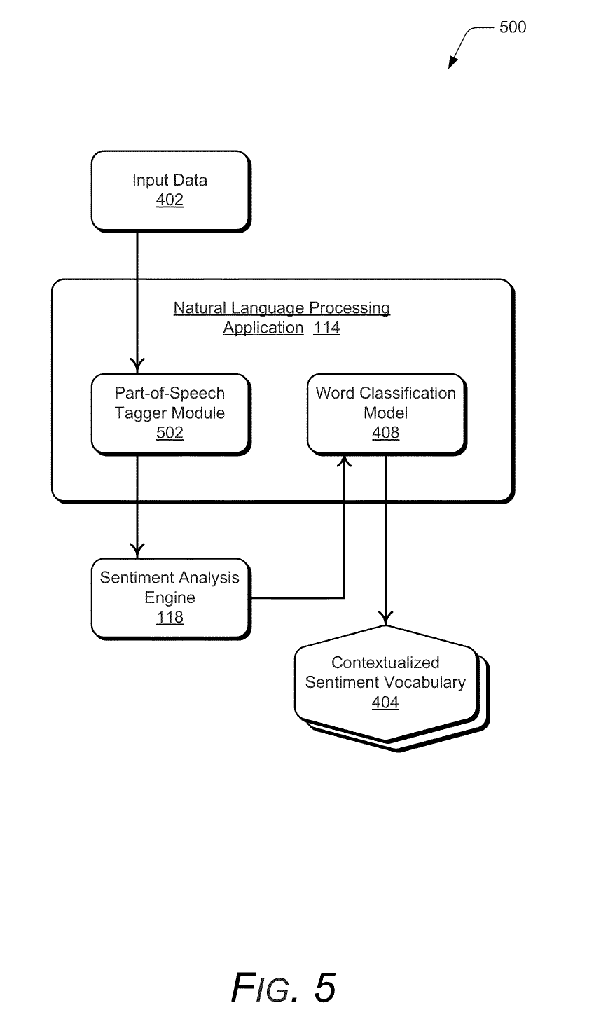

FIG. 5 illustrates an example implementation 500 of the natural language processing application 114 and the sentiment analysis engine 118 in embodiments of informative bounce rate. In this example, the natural language processing application 114 includes a part-of-speech (POS) tagger module 502 that is implemented to receive the input data 402, such as the target Web page 120 and the source content 122 as described with reference to FIG. 1. The POS tagger module 502 is a document, paragraph, and sentence segmenter, tokenizer, and a POS tagger using optimized lexical and contextual rules for grammar transformation, and generates a segmented and tokenized word punctuation list for each sentence of the input data. The POS module 502 also implements a high accuracy method for POS tagging the first term of sentiment sentences. This is a challenging problem due to the capitalization of a first term in a sentence, which makes it difficult for conventional POS taggers to differentiate between proper nouns, regular nouns, and adjectives.

In an implementation, the part-of-speech (POS) tagger module 502 can include the better characteristics of multiple POS tagger systems, which significantly improves the overall first word part-of-speech tagging accuracy. For example, the POS tagger module 502 can combine features of the Adobe Research Sedona Brill tagger, the open-source NLTK POS tagger, and the Stanford POS tagger. The output differences from each of the different part-of-speech taggers can be evaluated for correctness, and a set of heuristic rules created to generalize detection of error patterns when outputs are not in agreement. The correction heuristic can then be applied to the capitalized words in question. The POS tagger module 502 may also be implemented to employ an ensemble of diverse part-of-speech taggers and generate correction rules in real-time based on a voting outcome.

In embodiments, the word classification model 408 is scalable, rapid, and can utilize stochastic gradient descent. The word classification model 408 is implemented to receive the part-of-speech data that includes the noun expressions, verb expressions, and tagged parts-of-speech of the input data. In application of a machine learning framework, the sentiment analysis is treated as a text classification problem, where a model is trained to determine which set of classes need to be assigned to text. The text to be classified can be represented as a vector of numeric features values derived from words (also referred to as terms), phrases, or other properties of the documents. For the purposes of subsequent procedural description (without loss of generality), each document is represented as a vector of term frequencies.

The natural language processing application 114 and models are also implemented to take into account the use synonyms or antonyms to describe the same context. For instance, a particular user might use the term “large” whereas another might use the term “big”. Similarly, one user might use the term “fearful” whereas another might use “afraid” to describe a particular emotional state. Where possible, these terms are grouped together to for contextuality attribution at the right level of granularity in the calculations. Additionally, conjunctives are often used in sentiment expressions. For instance, conjunctives such as “but” are usually followed by a sentiment that is opposite of what appears before them. Other terms that have this property are “however”, “nevertheless”, “even though”, “with the exception of”, “in spite of”, and others. Similarly, “negation” rules such as “not” reverse the sentiment of a particular opinion term. Hence “not angry” has the opposite sentiment of “angry”.

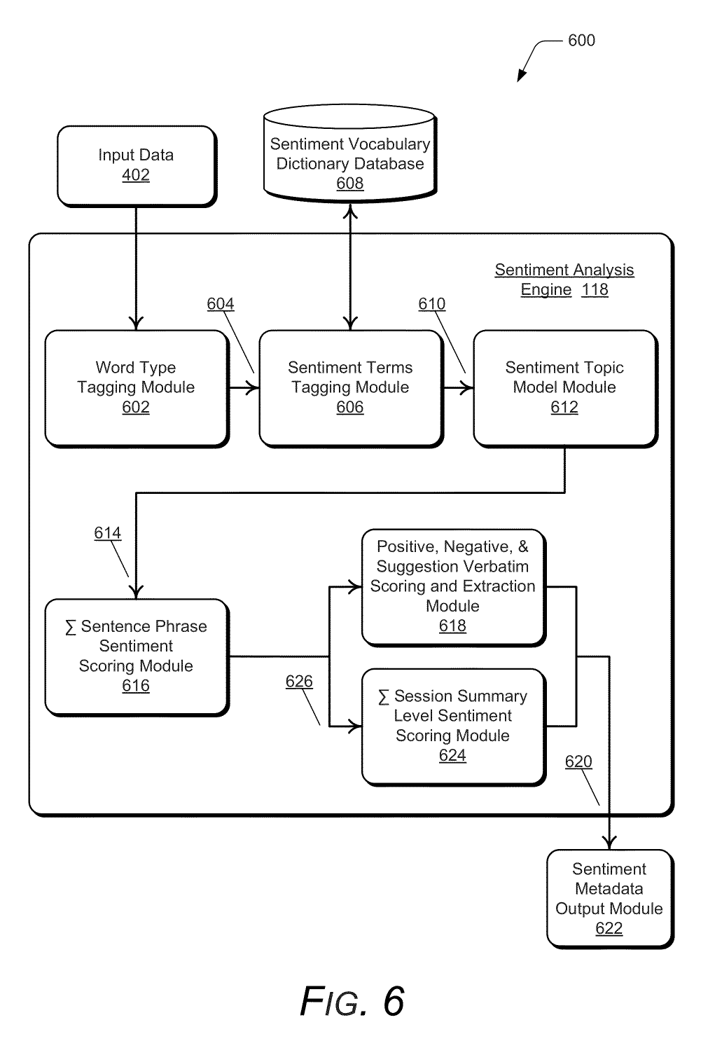

FIG. 6 illustrates an example implementation 600 of the sentiment analysis engine 118 as described with reference to FIG. 1, and that implements embodiments of informative bounce rate. The sentiment analysis engine 118 includes various modules that implement features of the sentiment analysis engine. Although shown and described as independent modules of the sentiment analysis engine, any one or combination of the various modules may be implemented together or independently in the sentiment analysis engine in embodiments of contextualized sentiment text analysis vocabulary generation.

The sentiment analysis engine 118 includes a word type tagging module 602 that is implemented to receive the input data 402 as the part-of-speech (POS) information that includes noun expressions, verb expressions, and tagged POS of one or more sentences. The input data 402 can include sentences that express positive, neutral, and negative sentiments, as well as suggestions and/or recommendations about a subject of a sentence. The word type tagging module 602 is implemented to identify and tag noun, verb, adjective and adverb sentence fragment expressions, as well as tag and group parts-of-speech of the sentences. The word type tagging module 602 provides a two-level sentence tagging structure for subsequent sentiment annotation. Terms within each fragment or phrase are first tagged with their part-of-speech (e.g., as a noun, verb, adjective, adverb, determiner, etc.), and then lexical expression types for each grouping of the terms and part-of-speech tags are assigned. The lexical expression types include noun expressions, verb expressions, and adjective expressions, and the word type tagging module 602 generates a two-level sentence expression and part-of-speech tag structure for each sentence, which is output at 604. The output structure identifies the elements of a sentence, such as where the noun expressions are most likely to occur in the sentence, and the adjective expressions that describe the elements in the sentence.

The sentiment analysis engine 118 also includes a sentiment terms tagging module 606 that is implemented to determine adjective forms of the adjective expressions utilizing a sentiment vocabulary dictionary database 608 to identify meaningful sentence phrases. The sentiment analysis engine 118 receives the POS annotated source terms and computes the sentiment polarity, intensity, and context for each submitted adjective, adverb, and noun term. The sentiment terms tagging module 606 can utilize the sentiment category vocabulary database 608, such as a default non-contextualized sentiment vocabulary that is constant across categories, or a domain specific contextualized sentiment vocabulary for selected categories, given one or more category context terms. The sentiment terms tagging module 606 can tag and annotate each sentiment term in the two-level tag structure, and generate an annotated data structure, which is output at 610.

The sentiment analysis engine 118 also includes a sentiment topic model module 612 that receives the annotated data structure and is implemented to identify and extract the key topic noun expressions from each sentence. In implementations, the sentiment topic model module 612 also accepts as input a sentiment neutral topic model, such as from the natural language processing application 114, and generates a weighted topic model indicating fine-grain sentiment for specific terms and/or lexical terms, such as the noun expressions and adjective expressions. The sentiment topic model module 612 tags the noun terms of a sentence that is processed as the input data 402 as topics of the sentence based on the noun expressions, and associates each of the topics with the sentiment about the subject of the sentence. The determined topics of the input sentence text data are output as a noun expressions topic model from the sentiment topic model module at 614.

The sentiment analysis engine 118 also includes a sentence phrase sentiment scoring module 616 that is implemented to aggregate the sentiment about the subject for each of the one or more topics of the sentence to score each of the noun expressions as represented by one of the topics of the sentence. The sentence phrase sentiment scoring module 616 computes the overall emotion and sentiment polarity and score for each topic model noun expression and sentence based on the earlier sentiment annotations and scores for each expression (or fragment) using individual term sentiment term scores and counts. The sentence and phrase-level sentiment scoring is performed to assign a positive or negative value score to each specific phrase within a sentence based on the presence of affect and sentiment keywords in that phrase. Phrase-level sentiment and affect scores are then summed to yield a sentence level score normalized by the total number of adjectives, adverbs, and nouns in the sentence. Sentences may have a zero score in the event that no sentiment or affect keywords are detected. The noun expression topic models are also retained at this stage for use by the sentiment metadata output module.

The sentiment analysis engine 118 also includes a positive, negative, and suggestion verbatim scoring and extraction module 618 that is implemented to determine and extract the highest scoring positive and negative sentiment sentences, as well as actionable suggestion and/or recommendation sentences, and collect them into separate lists to indicate the most important positive, negative, and suggestion verbatims. The important (e.g., high scoring) positive, negative, and suggestion sentences are identified and extracted by the extraction module 618 by ranking the sentences based on score and by detection of actionable terms and keywords. The extraction module 618 can be implemented with heuristics that use natural language and statistics to determine the most important positive and negative verbatims, as well as the recommendations and/or suggestions. The separate lists of the most important positive, negative, and suggestion verbatims can then be accessed at the output 620 by the sentiment metadata output module 622.

The sentiment analysis engine 118 also includes a session summary level sentiment scoring module 624 that is implemented to collect and count the positive and negative sentiment and affect contribution for all of the terms, and computes an aggregate affect and sentiment score. The sentence level sentiment score information and annotated terms from the sentence phrase sentiment scoring module 616 are input at 626 to the session summary level sentiment scoring module 624, which determines session or collection level sentiment scoring by computing a weighted average of all sentence sentiment scores. The sentiment scoring module 624 can be implemented to provide a measure of the net sentiment expressed in a group of sentences that typically represent a conversation or collection of feedback comments. The sentence-level and session-level sentiment and affect annotations, sentiment score metadata, part-of-speech statistics, and optional verbatim statements are forwarded to the sentiment metadata output module 622 at the output 620. The sentiment metadata output module 622 can then generate a formatted output from the sentiment analysis engine 118.

FIG. 7 illustrates an example system 700 that includes an example device 702, and in which techniques for informative bounce rate can be implemented. The example device 702 can be implemented as any of the computing devices and/or services (e.g., server devices) described with reference to the previous FIGS. 1-6, such as any type of computing device, client device, or server device. For example, the computing device 102 and/or the server device 108, as well as the Web service 104 and the cloud data storage 106 shown in FIG. 1, may be implemented as the example device 702.

The device 702 includes communication devices 704 that enable wired and/or wireless communication of device data 706, such as video content and image frames of the video content that is transferred from one computing device to another, and/or synched between multiple computing devices. The device data 706 can include any type of audio, video, and/or image data, such as application data that is generated by applications executing on the device. The communication devices 704 can also include transceivers for cellular phone communication and/or for network data communication.

The device 702 also includes data input/output (I/O) interfaces 708, such as data ports and data network interfaces that provide connection and/or communication links between the device, data networks, and other devices. The I/O interfaces can be used to couple the device to any type of components, peripherals, and/or accessory devices, such as a digital camera device that may be integrated with the device 702. The I/O interfaces also include data input ports via which any type of data, media content, and/or inputs can be received, such as user inputs to the device, as well as any type of audio, video, and/or image data received from any content and/or data source.

The device 702 includes a processing system 710 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 702 may further include any type of a system bus or other data and command transfer system that couples the various components within the device. A system bus can include any one or combination of different bus structures and architectures, as well as control and data lines.

The device 702 also includes computer-readable storage memory 712, such as data storage devices that can be accessed by a computing device, and that provide persistent storage of data and executable instructions (e.g., software applications, modules, programs, functions, and the like). Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 712 provides storage of the device data 706 and various device applications 714, such as an operating system that is maintained as a software application with the computer-readable storage memory and executed by the processing system 710. In this example, the device applications also include an analytics application 716 that implements the described techniques for informative bounce rate, such as when the example device 702 is implemented as the computing device 102 and/or the server device 108 shown in FIG. 1. Examples of the analytics application 716 include the analytics application 112 that is implemented by the computing device 102 and/or the server device 108 that is implemented by the Web service 104, as described with reference to FIGS. 1-6.

The device 702 also includes an audio and/or video system 718 that generates audio data for an audio device 720 and/or generates display data for a display device 722. The audio device and/or the display device include any devices that process, display, and/or otherwise render audio, video, display, and/or image data, such as the image content of a digital photo. In implementations, the audio device and/or the display device are integrated components of the example device 702. Alternatively, the audio device and/or the display device are external, peripheral components to the example device.

In embodiments, at least part of the techniques described for informative bounce rate may be implemented in a distributed system, such as over a “cloud” 724 in a platform 726. The cloud 724 includes and/or is representative of the platform 726 for services 728 and/or resources 730. For example, the services 728 and/or the resources 730 may include the Web service 104 and the analytics application 112 shown in FIG. 1 and described with reference to FIGS. 1-6.

The platform 726 abstracts underlying functionality of hardware, such as server devices (e.g., implemented by the Web service 104 and included in the services 728) and/or software resources (e.g., included as the resources 730), and connects the example device 702 with other devices, servers, etc. The resources 730 may also include applications and/or data that can be utilized while computer processing is executed on servers that are remote from the example device 702. Additionally, the services 728 and/or the resources 730 may facilitate subscriber network services, such as over the Internet, a cellular network, or Wi-Fi network. The platform 726 may also serve to abstract and scale resources to service a demand for the resources 730 that are implemented via the platform, such as in an interconnected device embodiment with functionality distributed throughout the system 700. For example, the functionality may be implemented in part at the example device 702 as well as via the platform 726 that abstracts the functionality of the cloud 724.

Although embodiments of informative bounce rate have been described in language specific to features and/or methods, the appended claims are not necessarily limited to the specific features or methods described. Rather, the specific features and methods are disclosed as example implementations of informative bounce rate.

1. A method, comprising:
obtaining keywords from content of a Web page;
extracting source content from a referring source that includes a selectable link to the Web page;
identifying each of the keywords that also occur in the source content of the referring source;
determining a sentiment associated with each keyword or phrase that also occurs in the source content, a phrase comprising one or more of the keywords from the content of the Web page and occurring in the source content of the referring source; and
generating a correspondence between the sentiment associated with a respective keyword or phrase and a bounce rate that is associated with the Web page.

2. The method as recited in claim 1, wherein obtaining the keywords comprises one of obtaining the keywords utilizing natural language processing applied to the Web page, or obtaining the keywords as provided by a marketer of the Web page.

3. The method as recited in claim 1, wherein obtaining the keywords comprises obtaining the keywords as provided by a marketer of the Web page, the keywords weighted according to an importance of the keywords, and the sentiment associated with a respective keyword or phrase determined based on the respective weighting of the keyword or the one or more keywords in the phrase.

4. The method as recited in claim 1, further comprising:
determining source keywords in the source content of the referring source utilizing natural language processing; and
wherein identifying each of the keywords that also occur in the source content comprises comparing the keywords from the content of the Web page to the source keywords determined from the source content.

5. The method as recited in claim 1, wherein the referring source comprises at least one of:
results generated by a search engine responsive to a keyword search, at least one of the results linking to the Web page;
an advertisement that includes the selectable link to the Web page;
a social media page that includes the source content linking to the Web page; or
a different, other Web page that includes the selectable link to the Web page.

6. The method as recited in claim 1, wherein extracting the source content from the referring source comprises extracting the source content from a page beginning of the referring source down to the selectable link to the Web page in the source content.

7. The method as recited in claim 1, wherein extracting the source content from the referring source comprises extracting the source content that is proximate the selectable link to the Web page in the source content.

8. The method as recited in claim 1, further comprising:
determining an overall source sentiment of the source content from the referring source based on an average of the sentiments that are each associated with a respective keyword or phrase.

9. The method as recited in claim 1, further comprising:
identifying the Web page to a marketer as needing a redesign, the Web page identified based on a high bounce rate and the referring source having a positive overall source sentiment.

10. The method as recited in claim 1, further comprising:
generating marketer results comprising the referring source, a number of Web page visits generated from the referring source, the bounce rate that is associated with the Web page for the number of Web page visits generated from the referring source, and an overall source sentiment of the referring source.

11. The method as recited in claim 1, further comprising:
generating marketer results comprising referring sources that each have a positive overall source sentiment, a number of Web page visits generated from the referring sources, the bounce rate that is associated with the Web page for the number of Web page visits generated from a respective referring source, and the positive overall source sentiment of the respective referring source.

12. The method as recited in claim 1, further comprising:
generating marketer results comprising a weighted sentiment-based bounce rate that indicates Web pages having a high bounce rate and corresponding referring sources that have a positive overall source sentiment.

13. A device, comprising:
a memory configured to maintain source content from one or more referring sources that include a selectable link to a Web page;
a processor system to implement an analytics application that is configured to:
obtain keywords from content of the Web page;
identify each of the keywords that also occur in the source content of the one or more referring sources;
associate a sentiment with each of the keywords that also occur in the source content, the sentiment that is associated with a respective keyword determined based on natural language processing and an overall sentiment cached in the memory with the source content;
generate a correspondence between the overall sentiment that is associated with the source content and a bounce rate that is associated with the Web page.

14. The device as recited in claim 13, wherein the processor system is configured to implement a natural language processing application to obtain the keywords from the content of the Web page.

15. The device as recited in claim 13, wherein the analytics application is configured to obtain the keywords of the Web page as provided by a marketer, the keywords weighted according to an importance of the keywords, and the sentiment that is associated with the respective keyword further determined based on the respective weighting of the keyword.

16. The device as recited in claim 13, wherein the analytics application is configured to extract the source content from the one or more referring sources as one of:
a page beginning of a referring source down to the selectable link to the Web page in the source content; or
the source content that is proximate the selectable link to the Web page in the source content.

17. The device as recited in claim 13, wherein the analytics application is configured to determine the overall source sentiment of the source content from a referring source based on an average of the sentiments that are each associated with a respective keyword.

18. The device as recited in claim 13, wherein the analytics application is configured to identify the Web page to a marketer as needing a redesign, the Web page identified based on a high bounce rate and one or more of the referring sources having a positive overall source sentiment.

19. A method, comprising:
obtaining keywords from content of a Web page utilizing natural language processing;
identifying each of the keywords that also occur in source content that includes a selectable link to the Web page;
associating a sentiment with each of the keywords that also occur in the source content;
determining an overall positive source sentiment or an overall negative source sentiment of the source content based on an average of the sentiments that are each associated with a respective keyword;
generate a correspondence between the overall positive source sentiment or the overall negative source sentiment that is associated with the source content and a bounce rate that is associated with the Web page.

20. The method as recited in claim 19, further comprising:
identifying the Web page as needing a redesign based on a high bounce rate and a corresponding overall positive source sentiment.
